(19) United States
(12) Patent Application Publication
(10) Pub. No.: US 2016/0064987 A1
(43) Pub. Date: Mar. 3, 2016

(54) WIRELESS-CHARGING BASE FOR CHARGING IN FLAT OR INCLINED POSITION

(71) Applicant: ORtek Technology, Inc., New Taipei City (TW)

(72) Inventors: Uen-Hour SHEU, New Taipei City (TW); Chi-Te HUANG, New Taipei City (TW)

(73) Assignee: ORtek Technology, Inc., New Taipei City (TW)

(21) Appl. No.: 14/511,383

(22) Filed: Oct. 10, 2014

(30) Foreign Application Priority Data
Aug. 29, 2014 (TW) 103215466

(51) Int. Cl. H02J 7/02; H02J 7/00

(52) U.S. Cl. CPC H02J 7/025; H02J 7/0042

(57) ABSTRACT

The present invention is to provide a wireless-charging base comprising a first casing, a second casing pivotally connected with the first casing, and a wireless-charging module installed in the first casing; wherein the first casing is configured to rotate against the second casing for allowing the base to be in a flat or an inclined supporting mode; in the flat supporting mode, bottom surfaces of the casings form a first surface for being placed on a plane, and top surfaces of the casings form a second surface for supporting an electronic device thereon; in the inclined supporting mode, the top surface of the first casing and the bottom surface of the second casing form an inclination angle for supporting the device; and a first coil in the module converts electric energy into electromagnetic fields and then transmits the electromagnetic fields to a second coil in the device through near-field induction.

### FIELD OF THE INVENTION

The present invention relates to a wireless-charging base for charging in flat or inclined position, and more particularly to a wireless-charging base with two pivotally connected casings for allowing the wireless-charging base to be in a flat or an inclined supporting mode supporting an electronic device alternatively.

### BACKGROUND OF THE INVENTION

As technologies rapidly develop in recent years, various novel electronic devices have been developed and produced one after another and have rendered daily living more convenient and comfortable, such as smartphones, electric vehicles, satellite navigation, event data recorders, etc. As these electronic devices are being used, they also gradually change our lifestyles; for example, since many of such electronic devices provides services via network connections, network signal stability has thus become a significant factor when evaluating the convenience and well-being of an environment. In addition, since such electronic devices have limited internal electricity storage, charging has also become an indispensable regular activity of modern daily living.

Taking smartphones for example, users commonly connected smartphones with power sources by cables for charging in the past; however, to further improve the convenience for the user, more and more manufacturers have adopted wireless-charging technology in smartphones. In fact, wireless-charging technology has been around for quite some time and is not some new technology just developed in recent years, and the main principle is not so complicated either; there are mainly two types of wireless charging: magnetic induction and magnetic resonance, where magnetic induction technology has coils respectively installed at the supplying end and the receiving end (i.e., the smartphone) and the coil at the supplying end generates a time-varying magnetic field according to current changes, and the coil at the receiving end generates induction current by electromagnetic induction for charging; in magnetic resonance technology, the supplying end and the receiving end are in resonance at the same frequency for high-energy transmission. The three mainstream transmission standards in the industry are Power Matters Alliance, Wireless Power Consortium, and Alliance for Wireless Power.

As smart devices popularize, wireless-charging technology gradually becomes the standard equipment of smart devices, and thus many manufacturers have started the designing of wireless-charging accessories. FIG. 1 shows a contemporary wireless-charging base A configured with a power module and a coil installed therein (not shown), and an inclined surface A1 is formed on one side; a protrusion A2 is configured at the bottom of the inclined surface A1 and the coil corresponds to the center of the inclined surface A1, so that the user may place the smartphone on the inclined surface A1 and the bottom of the smartphone is positioned by the protrusion A2 for wireless charging. However, as may be seen from the figure, the wireless-charging base A is bulky and has an irregular shape which is less convenient for the user to carry.

FIG. 2 shows another contemporary wireless-charging base B assembled by a first base body B1 and a second base body B2 and configured with an induction coil installed therein; an inclined surface B11 is configured on the first base body B1 and an anti-slip pad is configured on the inclined surface B11. Therefore, when the smartphone is placed on the inclined surface B11 of the first base body B1, it may be stably positioned on the first base body B1 by the anti-slip pad and the conformation of the wireless-charging base B may be kept simple. In addition, the first base body B1 may be designed to be pivotally connected with the second base body B2 movably so that the first base body B1 rotates against the second base body B2 to change the inclination angle of the inclined surface B11; however, such a design is less from perfect. Firstly, although the wireless-charging base B positions the smartphone via the friction force of the anti-slip pad, the smartphone may still be dislocated from the inclined surface B11 under impact by external forces, and may even tumble off along the inclined surface B11; secondly, although the first base body B1 may rotate against the second base body B2, such rotation only changes the inclination angle of the inclined surface B11, and cannot substantially change the volume and conformation of the wireless-charging base B, and thus the issue of inconvenience in carrying remains.

Therefore, the design of a novel wireless-charging base that not only wirelessly charges electronic devices such as smartphones steadily but also changes conformation or using mode to facilitate carrying by the user, and further render the usage of wireless-charging bases more flexible is the crucial topic to be solved in this invention.

### BRIEF SUMMARY OF THE INVENTION

In view of the bulky sizes of conventional wireless-charging bases that are less beneficial for users to carry, years of practice and numerous studies and tests have finally yielded a wireless-charging base of the present invention for charging in flat or inclined position expected to promote the convenience and usage flexibility of wireless charging by the novel structure.

A purpose of the invention is to provide a wireless-charging base for charging in flat or inclined position and comprises a first casing, a second casing, and a wireless-charging module, wherein the second casing is pivotally connected at an angle with the first casing so that the first casing is configured to rotate against the second casing for allowing the wireless-charging base to be in a flat supporting mode or an inclined supporting mode, alternatively, wherein in the flat supporting mode, a bottom surface of the first casing and a bottom surface of the second casing collectively form a first surface to be placed on a planar object, and a top surface of the first casing and a top surface of the second casing collectively form a second surface for supporting an electronic device thereon, and wherein in the inclined supporting mode, the top surface of the first casing and the bottom surface of the second casing form an inclination angle smaller than 90°, so that the top surface of the first casing is leaned against by and supports the electronic device when the bottom surface of the second casing is placed on the planar object; the wireless-charging module is installed in the first casing and converts electric energy into electromagnetic fields by a first coil installed therein, wherein the electromagnetic fields are transmitted to a second coil installed in the electronic device through near-field induction, so that the electronic device converts the electromagnetic fields into electric energy. Therefore, the user may adjust the wireless-charging base into the flat supporting mode to facilitate carrying or charging, or may adjust the wireless-charging base into the inclined supporting mode, so that the user may view the information displayed on the screen of the electronic device when the electronic device is undergoing wireless charging.

A second purpose of the invention is that a first slant is configured on an end of the first casing and a first pivotal connection portion is configured on the first slant, and a second slant is configured on an end of the second casing and a second pivotal connection portion is configured on the second slant, and the inclination angles of the first slant and the second slant are matched, so that the first slant and the second slant coincide when the first pivotal connection portion is pivotally connected with the second pivotal connection portion. Therefore, the first surface is parallel with the second surface in the flat supporting mode, so that the wireless-charging base may have the most planar conformation.

### BRIEF DESCRIPTION OF DRAWINGS

FIG. 1 is a schematic of a conventional wireless-charging base;

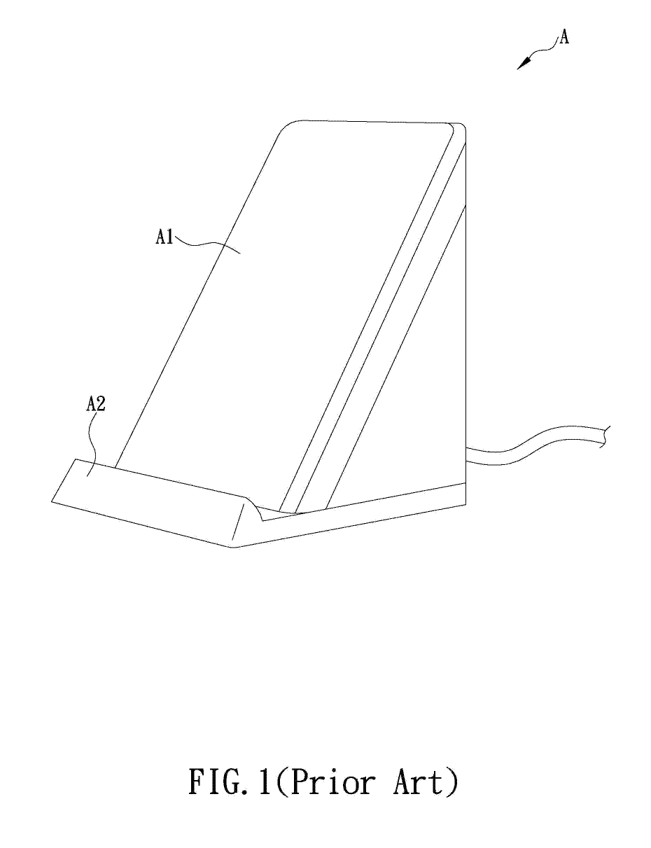

FIG. 2 is a schematic of another conventional wireless-charging base;

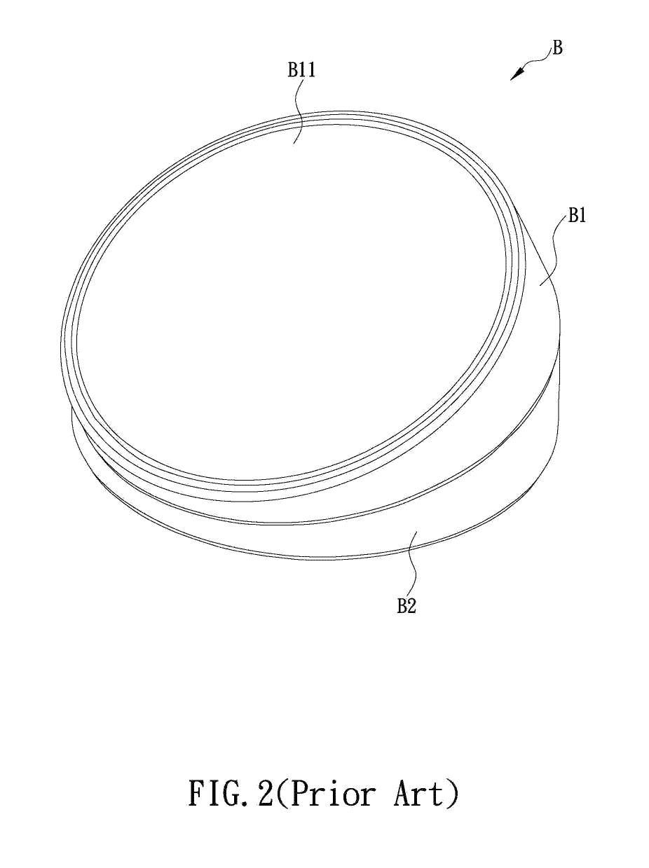

FIG. 3 shows a first embodiment of a wireless-charging base of the invention;

FIG. 4 shows a coil in the wireless-charging base of the invention;

FIG. 5 shows the wireless-charging base of the invention in a flat supporting mode;

FIG. 6 shows the wireless-charging base of the invention in an inclined supporting mode;

FIG. 7 shows a first casing of the wireless-charging base of the invention;

FIG. 8 shows a second embodiment of the wireless-charging base of the invention;

FIG. 9 shows a third embodiment of the wireless-charging base of the invention; and

FIG. 10 shows the third embodiment of the wireless-charging base of the invention in usage.

### DETAILED DESCRIPTION OF THE INVENTION

The principles, structural features, and purposes of the invention may be more fully understood by the subsequent detailed description and examples with references made to the accompanying drawings.

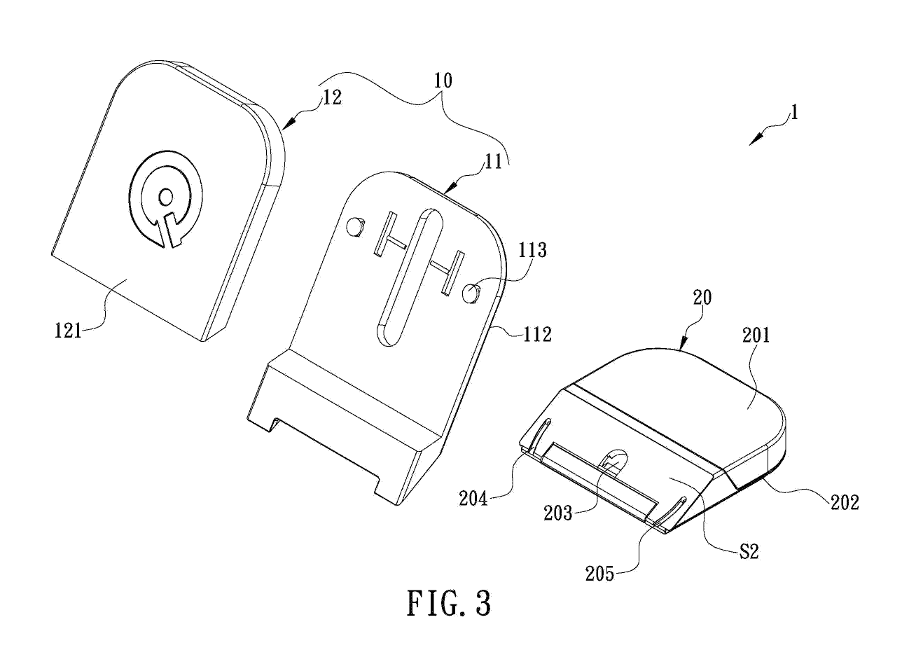

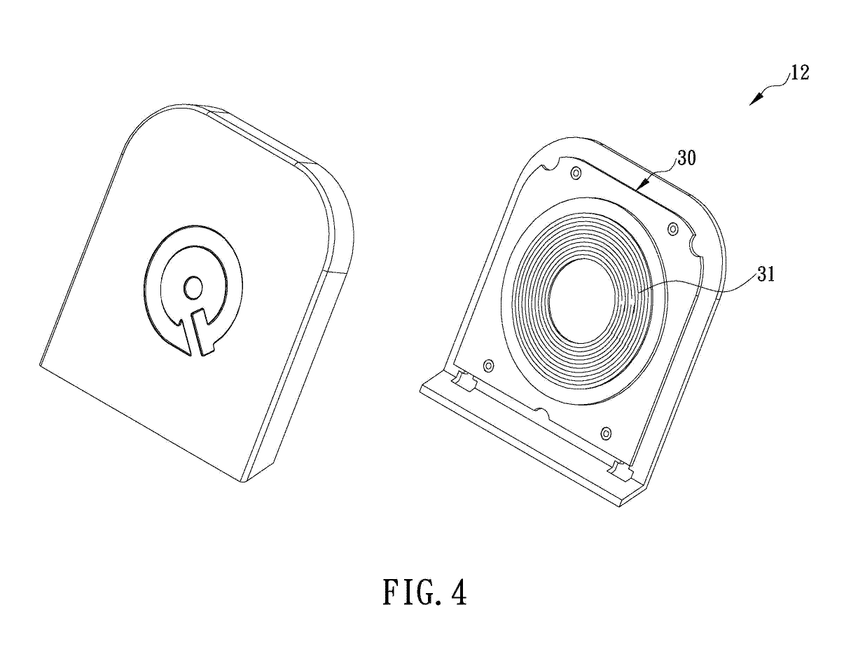

The invention pertains to a wireless-charging base for charging in flat or inclined position, and FIG. 3 and FIG. 4 show a first preferred embodiment of the invention. The wireless-charging base 1 comprises a first casing 10, a second casing 20, and a wireless-charging module 30, wherein an end of the first casing 10 is pivotally connected with an end of the second casing 20, so that the first casing 10 and the second casing 20 are assembled at an angle; the wireless-charging module 30 is installed in the first casing 10 and at least comprises a first coil 31, wherein the wireless-charging module 30 is connected to a power supply unit (e.g., a plug socket) via a cable to receive electric energy transmitted from the power supply unit and convert electric energy into electromagnetic fields by the first coil 31. It should be noted that the cable is omitted in FIG. 3 and FIG. 4 for simplicity, and a connection socket electrically connected with the first coil 31 may be configured on the first casing 10 or the second casing 20 in practice, so that the cable may be plugged into the connection socket to connect the wireless-charging base 1 with the power supply unit.

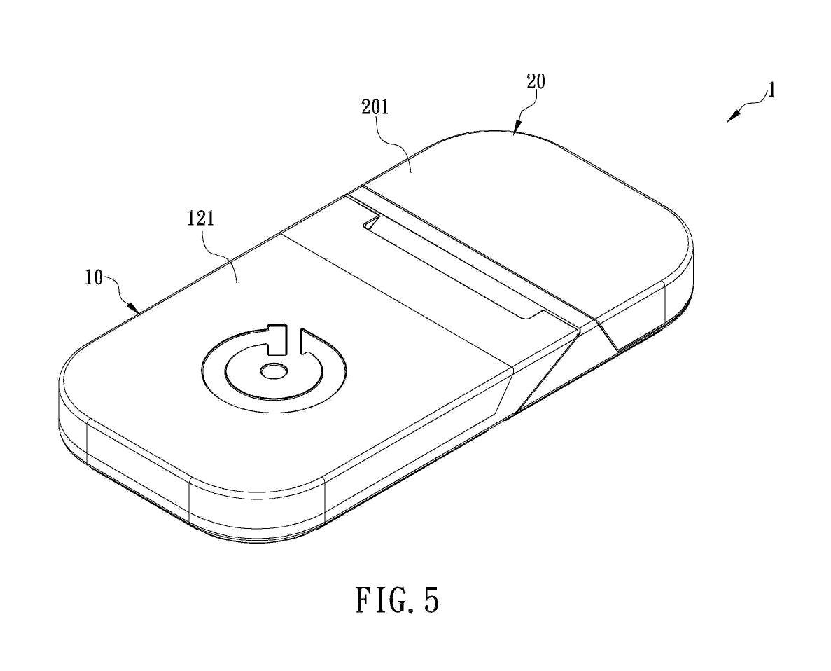

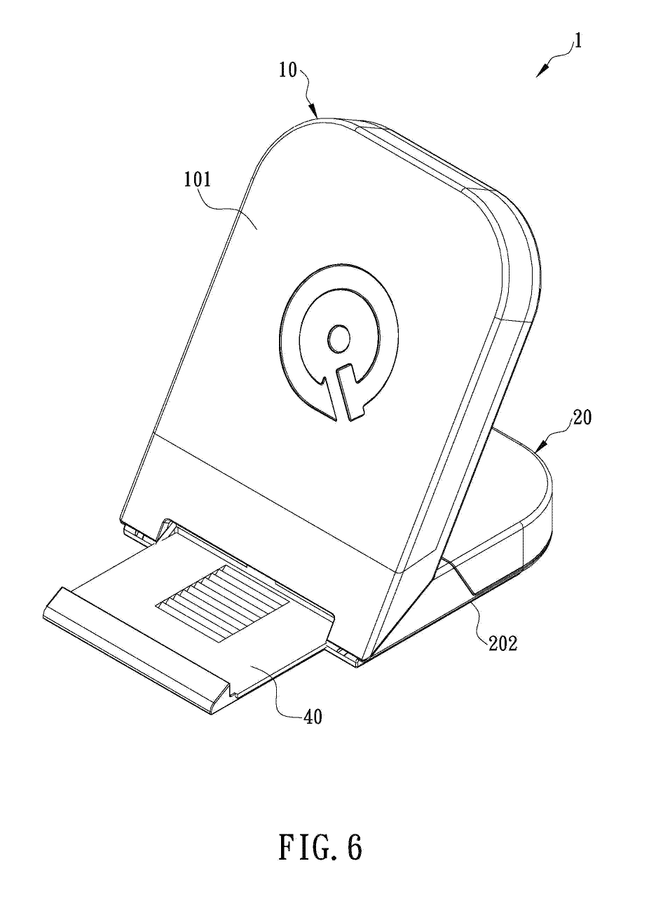

Referring to FIG. 3 to FIG. 6, the end of the first casing 10 may rotate against the end of the second casing 20, and the wireless-charging base 1 may be configured in a flat supporting mode (as shown in FIG. 5) or an inclined supporting mode, alternatively (as shown in FIG. 6). In the flat supporting mode, a bottom surface 112 of the first casing 10 and a bottom surface 202 of the second casing 20 may collectively form a first surface so that the wireless-charging base 1 may be placed on a planar object (e.g., a desk) by the first surface, and a top surface 121 of the first casing 10 and a top surface 201 of the second casing 20 may collectively form a second surface parallel with the first surface, so that an electronic device (e.g., a tablet, a smartphone, or a smartwatch) may be placed flat and supported on the second surface.

On the other hand, in the inclined supporting mode, the top surface 121 of the first casing 10 and the bottom surface 202 of the second casing 20 form an inclination angle smaller than 90°, so that the top surface 121 of the first casing 10 may be leaned against by and support a bottom surface of the electronic device (i.e., the side opposite to the screen of the electronic device) when the bottom surface 202 of the second casing 20 is placed on the planar object, so as to retain the inclination angle between the electronic device and the planar object. The location of the first coil 31 in the wireless-charging base 1 may correspond to a second coil in the electronic device whether in the flat supporting mode or the inclined supporting mode, so that the electromagnetic fields generated by the first coil 31 may be transmitted to the second coil through near-field induction (i.e., inductive coupling), and the first coil 31 and the second coil are equivalent to the primary coil and the secondary coil of a transformer, so that the electronic device may convert the electromagnetic fields into electric energy for the electronic device to used or store.

Therefore, as energy is transmitted between the wireless-charging base 1 and the electronic device entirely by inductive coupling, no cable connection between them is required, and thus the wireless-charging base 1 and the electronic device may implement designs with no exposed conductive connectors; in addition, since the first casing 10 may rotate against the second casing 20, the two may become the flat supporting mode for packing or carrying and wireless charging with the electronic device lying flat thereon, or may become the inclined supporting mode for the user to clearly and easily view the information displayed on the screen on top of the electronic device when the electronic device is undergoing wireless charging with the bottom surface of the electronic device leaning inclined against the top surface 121 of the first casing 10 due to the inclination angle.

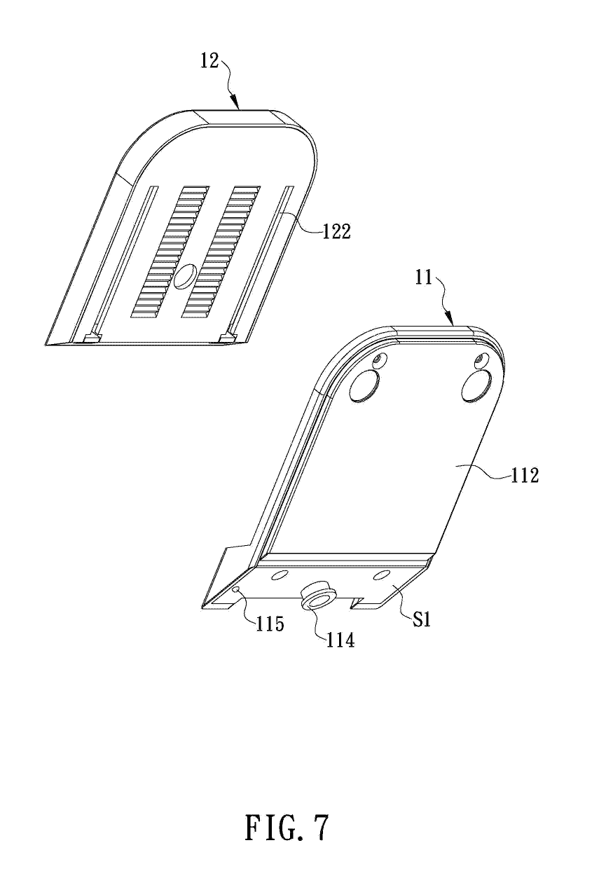

Referring to FIG. 3 and FIG. 7, in the first preferred embodiment of the invention, the first casing 10 comprises a fixed base 11 and a movable casing 12, wherein the fixed base 11 is pivotally connected at an angle with the second casing 20 so that the fixed base 11 rotates against the second casing 20, and the wireless-charging base 1 is configured in the flat supporting mode or the inclined supporting mode, alternatively, wherein a bottom surface of the fixed base 11 is the bottom surface 112 of the first casing 10, and a top surface of the fixed base 11 is configured with at least one first rail device 113. A top surface of the movable casing 12 is the top surface 121 of the first casing 10, and a bottom surface of the movable casing 12 is configured with at least one second rail device 122 (e.g., a rail groove) corresponding to the first rail device 113, and an end of the second rail device 122 extends to an end of the movable casing 12 and forms an opening, so that the first rail device 113 may enter the second rail device 122 from the opening, and the movable casing 12 is movably engaged on the fixed base 11 and moves with respect to the fixed base 11 along the direction of the second rail device 122. Therefore, the user may adjust the height of the first coil 31 to work with electronic devices of different sizes (e.g., smartphones, tablets, etc.).

Referring to FIG. 3 to FIG. 7, in the flat supporting mode, the bottom surface 112 of the fixed base 11 and the bottom surface 202 of the second casing 20 collectively form the first surface, and the top surface 121 of the movable casing 12 and the top surface 201 of the second casing 20 collectively form the second surface; similarly, in the inclined supporting mode, the top surface 121 of the movable casing 12 and the bottom surface 202 of the second casing 20 form the inclination angle, so that the top surface 121 of the movable casing 12 is leaned against by and supports the bottom surface of the electronic device when the bottom surface 202 of the second casing 20 is placed on the planar object, so as to retain the inclination angle between the electronic device and the planar object. In this embodiment, the wireless-charging module 30 is installed in the movable casing 12, so that the first coil 31 of the wireless-charging module 30 may move with the movable casing 12 and be adjusted to keep an optimum near-field induction position with respect to the second coil in the electronic device.

To further understand the structural features of the invention, the pivotal connection scheme of the invention is described referring to FIG. 3 and FIG. 7. In this embodiment, a first slant S1 is configured on an end of the first casing 10 (i.e., an end of the fixed base 11) and a first pivotal connection portion 114 (such as a pivotal connection shaft) is configured on the first slant S1, and a second slant S2 is configured on an end of the second casing 20 and a second pivotal connection portion 203 (such as a pivotal connection slot) is configured on the second slant S2, and the inclination angles of the first slant S1 and the second slant S2 are matched, so that the first slant S1 and the second slant S2 coincide when the first pivotal connection portion 114 is pivotally connected with the second pivotal connection portion 203. Therefore, the first surface is parallel with the second surface, and the top surface 121 of the first casing 10 and the top surface 201 of the second casing 20 retain the same height in the flat supporting mode, so that the wireless-charging base 1 may have the most planar conformation.

An engagement portion 115 is further configured on the first slant S1 in the vicinity of the first pivotal connection portion 114, and a first engagement groove 204 and a second engagement groove 205 are configured on the second slant S2, and the engagement portion 115 is engaged in the first engagement groove 204 when the wireless-charging base 1 is in the flat supporting mode; when the user wishes to change the wireless-charging base 1 into the inclined supporting mode, the user only has to rotate the first casing 10, so that the engagement portion 115 disengages from the first engagement groove 204 and rotates towards the second engagement groove 205 to let the wireless-charging base 1 form the inclined supporting mode; at this moment, the engagement portion 115 is engaged in the second engagement groove 205 to ensure the positional stability of the first casing 10.

The aforementioned pivotal connection scheme is only a preferred embodiment of the invention, and other schemes may be used to pivotally connect the first casing 10 and the second casing 20 (e.g., by universal bearings), and the coincidence of the first slant S1 and the second slant S2 is also not a necessary limitation of the invention. One of the key concepts of the invention is to form two different supporting modes via the relative rotation of the first casing 10 and the second casing 20: the inclined supporting mode is convenient for the user to view the electronic device at the same time, while the flat supporting mode has a larger surface for supporting and the overall thickness is far more smaller than the inclined supporting mode which is easier for carrying.

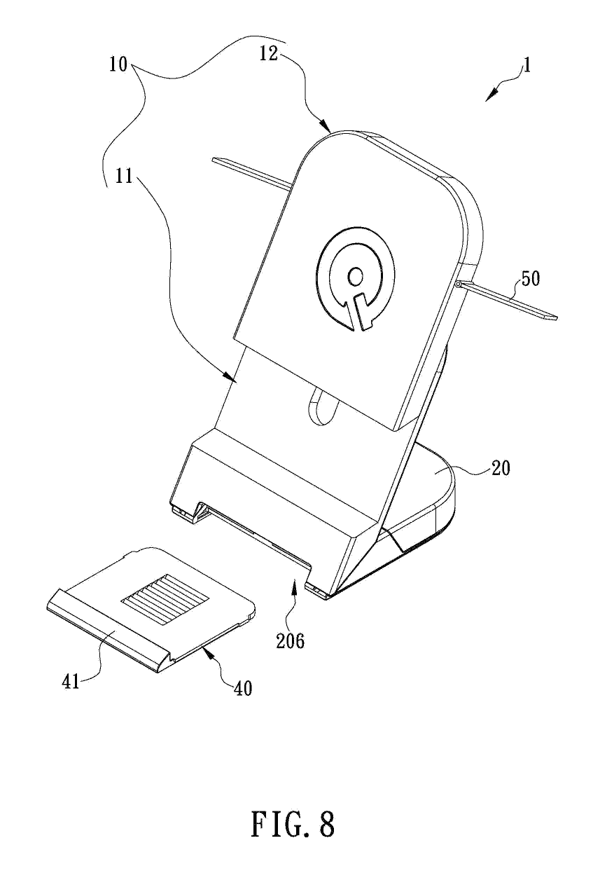

Referring to FIG. 8, the wireless-charging base 1 further comprises a stopping plate 40 movably engaged in the second casing 20 in the vicinity of a pivotal connection between the second casing 20 and the first casing 10; in this embodiment, the stopping plate 40 may be received in a receiving slot 206 opened on an end of the second casing 20, and a protrusion 41 is configured on an end of the stopping plate 40. The stopping plate 40 is received in the receiving slot 206 in the flat supporting mode, and is pulled outside the second casing 20 in the inclined supporting mode to support a side of the electronic device between the top surface and bottom surface, and the protrusion 41 may block a bottom edge of the top surface of the electronic device to restrict the position of the electronic device, so that the coils of the wireless-charging base 1 and the electronic device may keep an optimum near-field induction distance.

Again referring to FIG. 3, FIG. 4, and FIG. 8, in a second preferred embodiment of the invention, the wireless-charging base 1 further comprises at least one supporting device 50 pivotally connected to the first casing 10 or the movable casing 12 corresponding to the location of the first coil 31; in the flat supporting mode, the supporting device 50 may be received within the first casing 10 or the movable casing 12; in the inclined supporting mode, the supporting device 50 may be flipped outside the first casing 10 or the movable casing 12 to support a wearable electronic device (e.g., a watchband of a smartwatch), so that the second coil in the wearable electronic device may be adjusted to keep an optimum near-field induction position with respect to the first coil 31 of the wireless-charging module 30.

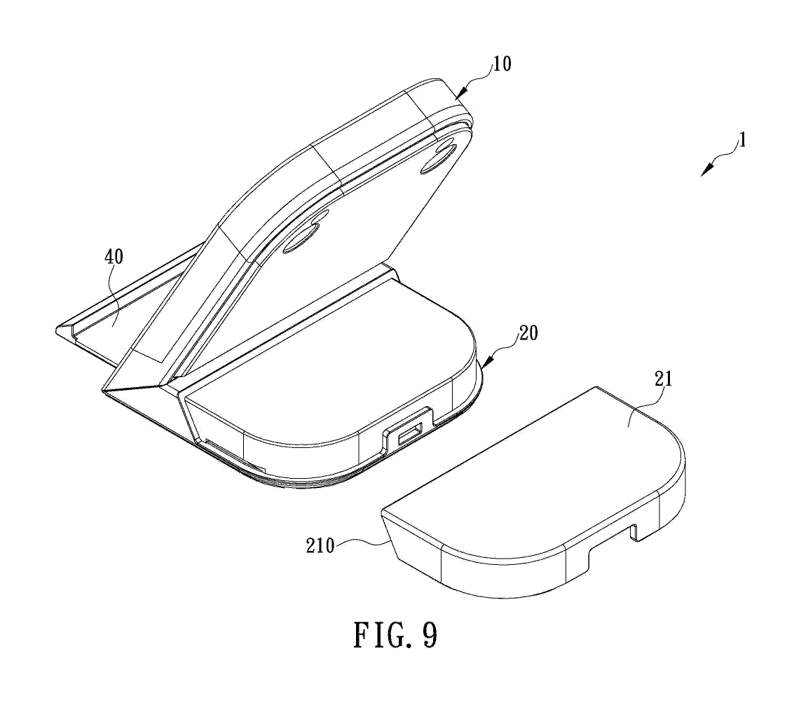

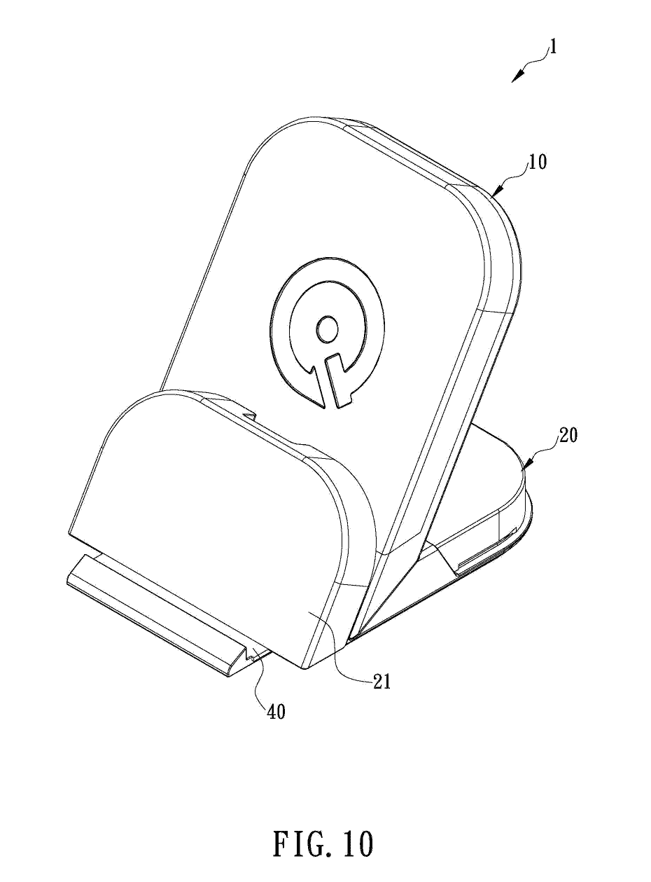

FIG. 9 and FIG. 10 show a third preferred embodiment of the invention; in this embodiment, a cover 21 is configured in the vicinity of the other end of the top of the second casing 20 (i.e., opposite to the end pivotally connected to the first casing 10), and is engaged and assembled on the second casing 20; when the wireless-charging base 1 is in the inclined supporting mode, the cover 21 may be placed on the stopping plate 40 after being removed from the second casing 20 (as shown in FIG. 10), and thus the height of the stopping plate 40 may be increased for placing other smaller electronic devices (such as MP3 players, smartwatches, smart glasses, etc.). In addition, a fitting slant 210 is configured on an end of the cover 21, and has a slope matching the angle between the first casing 10 and the second casing 20, so that the cover 21 may closely fit on the stopping plate 40 and the first casing 10.

While the invention herein disclosed has been described by means of specific embodiments, numerous modifications and variations could be made thereto by those skilled in the art without departing from the scope of the invention set forth in the claims.

What is claimed is:

1. A wireless-charging base for charging in flat or inclined position, comprising:
a first casing;
a second casing, pivotally connected at an angle with the first casing so that the first casing is configured to rotate against the second casing for allowing the wireless-charging base to be in a flat supporting mode or an inclined supporting mode, alternatively, wherein in the flat supporting mode, a bottom surface of the first casing and a bottom surface of the second casing collectively form a first surface to be placed on a planar object, and a top surface of the first casing and a top surface of the second casing collectively form a second surface for supporting an electronic device thereon, and wherein in the inclined supporting mode, the top surface of the first casing and the bottom surface of the second casing form an inclination angle smaller than 90°, so that the top surface of the first casing is leaned against by and supports the electronic device when the bottom surface of the second casing is placed on the planar object; and
a wireless-charging module, installed in the first casing and converting electric energy into electromagnetic fields by a first coil installed therein, wherein the electromagnetic fields are transmitted to a second coil installed in the electronic device through near-field induction, so that the electronic device converts the electromagnetic fields into electric energy.

2. The wireless-charging base as claimed in claim 1, wherein a first slant is configured on an end of the first casing, and a first pivotal connection portion is configured on the first slant, a second slant is configured on an end of the second casing, and a second pivotal connection portion is configured on the second slant, and the inclination angles of the first slant and the second slant are matched, so that the first slant and the second slant coincide when the first pivotal connection portion is pivotally connected with the second pivotal connection portion.

3. The wireless-charging base as claimed in claim 2, wherein an engagement portion is configured on the first slant in the vicinity of the first pivotal connection portion, and a first engagement groove and a second engagement groove are configured on the second slant, and the engagement portion is engaged in the first engagement groove when the wireless-charging base is in the flat supporting mode, and the engagement portion is engaged in the second engagement groove when the wireless-charging base is in the inclined supporting mode.

4. The wireless-charging base as claimed in claim 3, wherein the wireless-charging base further comprises a stopping plate movably engaged in the second casing in the vicinity of a pivotal connection between the second casing and the first casing.

5. The wireless-charging base as claimed in claim 4, wherein the stopping plate is received in a receiving slot in the second casing and can be pulled outside the second casing while in the inclined supporting mode.

6. The wireless-charging base as claimed in claim 5, wherein a protrusion is configured on an end of the stopping plate.

7. The wireless-charging base as claimed in claim 6, wherein a cover is configured in the vicinity of the other end of the second casing and can be placed on the stopping plate after being removed from the second casing.

8. The wireless-charging base as claimed in claim 1, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

9. The wireless-charging base as claimed in claim 2, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

10. The wireless-charging base as claimed in claim 3, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

11. The wireless-charging base as claimed in claim 4, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

12. The wireless-charging base as claimed in claim 5, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

13. The wireless-charging base as claimed in claim 6, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

14. The wireless-charging base as claimed in claim 7, wherein the first casing further comprises:
a fixed base, pivotally connected at an angle with the second casing so that the fixed base is configured to rotate against the second casing for allowing the wireless-charging base to be in the flat supporting mode or the inclined supporting mode, wherein a bottom surface of the fixed base is the bottom surface of the first casing, and a top surface of the fixed base is configured with at least one first rail device; and
a movable casing, having a top surface to be the top surface of the first casing and a bottom surface configured with at least one second rail device corresponding to the first rail device so that the movable casing is movably engaged on the fixed base and moves with respect to the fixed base through the second rail device.

15. The wireless-charging base as claimed in claim 8, wherein the first surface is parallel with the second surface.

16. The wireless-charging base as claimed in claim 9, wherein the first surface is parallel with the second surface.

17. The wireless-charging base as claimed in claim 10, wherein the first surface is parallel with the second surface.

18. The wireless-charging base as claimed in claim 11, wherein the first surface is parallel with the second surface.

19. The wireless-charging base as claimed in claim 12, wherein the first surface is parallel with the second surface.

20. The wireless-charging base as claimed in claim 13, wherein the first surface is parallel with the second surface.

21. The wireless-charging base as claimed in claim 14, wherein the first surface is parallel with the second surface.
